(19) United States
(12) Patent Application Publication
(10) Pub. No.: US 2019/0331037 A1
(43) Pub. Date: Oct. 31, 2019

(54) HYBRID VEHICLE AND CONTROL DEVICE FOR HYBRID VEHICLE

(71) Applicant: TOYOTA JIDOSHA KABUSHIKI KAISHA, Toyota-shi (JP)

(72) Inventors: Kenji SUZUKI, Gotemba-shi (JP); Yoshihiro SAKAYANAGI, Mishima-shi (JP); Sui KURIHASHI, Susono-shi (JP); Yoshiyuki KAGEURA, Sunto-gun (JP)

(73) Assignee: TOYOTA JIDOSHA KABUSHIKI KAISHA, Toyota-shi (JP)

(21) Appl. No.: 16/394,682

(22) Filed: Apr. 25, 2019

(30) Foreign Application Priority Data
Apr. 27, 2018 (JP) 2018-087137

(51) Int. Cl. F02D 41/00; B60W 20/00; B60K 6/40; B60K 15/035; B60K 6/28; B60W 10/08; B60W 10/06; F02M 25/08; F01N 3/20; F01N 9/00

(52) U.S. Cl. CPC F02D 41/004; B60W 20/00; B60K 6/40; B60K 15/03504; B60K 6/28; B60W 10/08; B60Y 2200/92; F02M 25/08; F01N 3/2013; F01N 9/00; B60W 2550/12; B60W 2710/06; B60W 10/06

(57) ABSTRACT

A control device for a vehicle configured provided with a temperature raising control part performing temperature raising control supplying current to a heating element to make a temperature of a catalyst rise when it is judged that a time elapsed from when an internal combustion engine was stopped during a stopped time of the vehicle has become a predetermined time or more and a purge control part performing purge control performing motoring of the internal combustion engine and opening a purge valve when the temperature of the catalyst has become a predetermined temperature or more or when a time of supply of current to the heating element has become a predetermined time or more such that fuel particles held by adsorption at the inside of a canister is discharged into the intake passage to supply them to a catalyst device.

### CROSS-REFERENCE TO RELATED APPLICATION

This application claims priority based on Japanese Patent Application No. 2018-087137 filed with the Japan Patent Office on Apr. 27, 2018, the entire contents of which are incorporated into the present specification by reference.

### FIELD

The present invention relates to a hybrid vehicle and a control device for a hybrid vehicle.

### BACKGROUND

Japanese Unexamined Patent Publication No. 2008-195214 discloses as a conventional control device for a hybrid vehicle one which is configured for plug-in charging for charging electric power of an external power source into a battery during which heating a canister by a heater to render fuel particles in fuel evaporative emission adsorbed at activated carbon inside the canister a state easy to be desorbed from the activated carbon and to drive the internal combustion engine at the time of startup of the vehicle so as to enable the fuel particles adsorbed at the activated carbon inside the canister to be introduced into a combustion chamber of the internal combustion engine and made to burn in a short time period from when starting up the vehicle.

### SUMMARY OF INVENTION

However, fuel evaporative emission occurs inside a fuel tank even in a stopped time of a vehicle from when the vehicle is stopped to when it is restarted. Further, in the case of a hybrid vehicle, even if the vehicle is restarted, the internal combustion engine will not necessarily be driven, so the time period during which the internal combustion engine remains stopped tends to become longer. For this reason, in a conventional control device of a hybrid vehicle like the one described above, even if designed to drive the internal combustion engine when the vehicle is restarted, fuel evaporative emission is liable to leak to the outside and be discharged into the atmosphere during the stopped time of the vehicle.

The present invention was made focusing on such a problem and has as its object to keep fuel evaporative emission from leaking to the outside and being discharged into the atmosphere during the stopped time of a hybrid vehicle.

To solve this problem, according to one aspect of the present invention, there is provided a control device for a hybrid vehicle. The hybrid vehicle comprises an internal combustion engine, a fuel tank storing fuel for supply to the internal combustion engine, a canister adsorbing and holding inside it fuel particles in fuel evaporative emission occurring in the fuel tank, a purge passage connecting an intake passage of the internal combustion engine and the canister, a purge valve provided in the purge passage to open and close the purge passage, a rechargeable battery, an electrical heated catalyst device provided in an exhaust passage of the internal combustion engine and including a heating element generating heat by electric power supplied from the battery and a catalyst heated through the heating element, a first rotary electric machine driven by electric power supplied from the battery and able to perform motoring of the internal combustion engine and a second rotary electric machine driven by at least electric power supplied from the battery. The hybrid vehicle is configured to be able to transmit power of one or both of the internal combustion engine and second rotary electric machine to a driven object. The control device comprises a judging part configured to judge if a time elapsed from when the internal combustion engine was stopped became a predetermined time or more during a stopped time of the hybrid vehicle, a temperature raising control part configured to perform temperature raising control running current through the heating element to make the temperature of the catalyst rise when it was judged that the elapsed time became a predetermined time or more and a purge control part configured to perform purge control performing motoring of the internal combustion engine by the first rotary electric machine and opening the purge valve when the temperature of the catalyst has become a predetermined temperature or more or when a time of supply of current to the heating element has become a predetermined time or more such that fuel particles held by adsorption at the inside of the canister is discharged into the intake passage to supply them to the catalyst device.

To solve this problem, according to another aspect of the present invention, there is provided a hybrid vehicle. The hybrid vehicle comprises an internal combustion engine, a fuel tank storing fuel for supply to the internal combustion engine, a canister adsorbing and holding inside it fuel particles in fuel evaporative emission occurring in the fuel tank, a purge passage connecting an intake passage of the internal combustion engine and the canister, a purge valve provided in the purge passage to open and close the purge passage, a rechargeable battery, an electrical heated catalyst device provided in an exhaust passage of the internal combustion engine and including a heating element generating heat by electric power supplied from the battery and a catalyst heated through the heating element, a first rotary electric machine driven by electric power supplied from the battery and able to perform motoring of the internal combustion engine, a second rotary electric machine driven by at least electric power supplied from the battery and a control device. The hybrid vehicle is configured to be able to transmit power of one or both of the internal combustion engine and second rotary electric machine to a driven object. The control device is configured to judge if a time elapsed from when the internal combustion engine was stopped became a predetermined time or more during a stopped time of the hybrid vehicle, to perform temperature raising control running current through the heating element to make the temperature of the catalyst rise when it was judged that the elapsed time became a predetermined time or more, and to perform purge control performing motoring of the internal combustion engine by the first rotary electric machine and opening the purge valve when the temperature of the catalyst has become a predetermined temperature or more or when a time of supply of current to the heating element has become a predetermined time or more such that fuel particles held by adsorption at the inside of the canister is discharged into the intake passage to supply them to the catalyst device.

According to these aspect of the present invention, it is possible to keep fuel evaporative emission from leaking to the outside and being discharged into the atmosphere in the stopped time of a hybrid vehicle.

### BRIEF DESCRIPTION OF DRAWINGS

FIG. 1 is a schematic view of the configuration of a vehicle and an electronic control unit controlling the vehicle according to one embodiment of the present invention.

FIG. 2 is a view explaining the configuration of a fuel evaporative emission treatment device according to one embodiment of the present invention which the internal combustion engine is provided with.

FIG. 3 is a flow chart for explaining stop purge control according to one embodiment of the present invention.

FIG. 4 is a flow chart for explaining stop purge control according to a modification of the present invention.

### DESCRIPTION OF EMBODIMENTS

Below, referring to the drawings, embodiments of the present invention will be explained in detail. Note that in the following explanation, similar component elements will be assigned the same reference numerals.

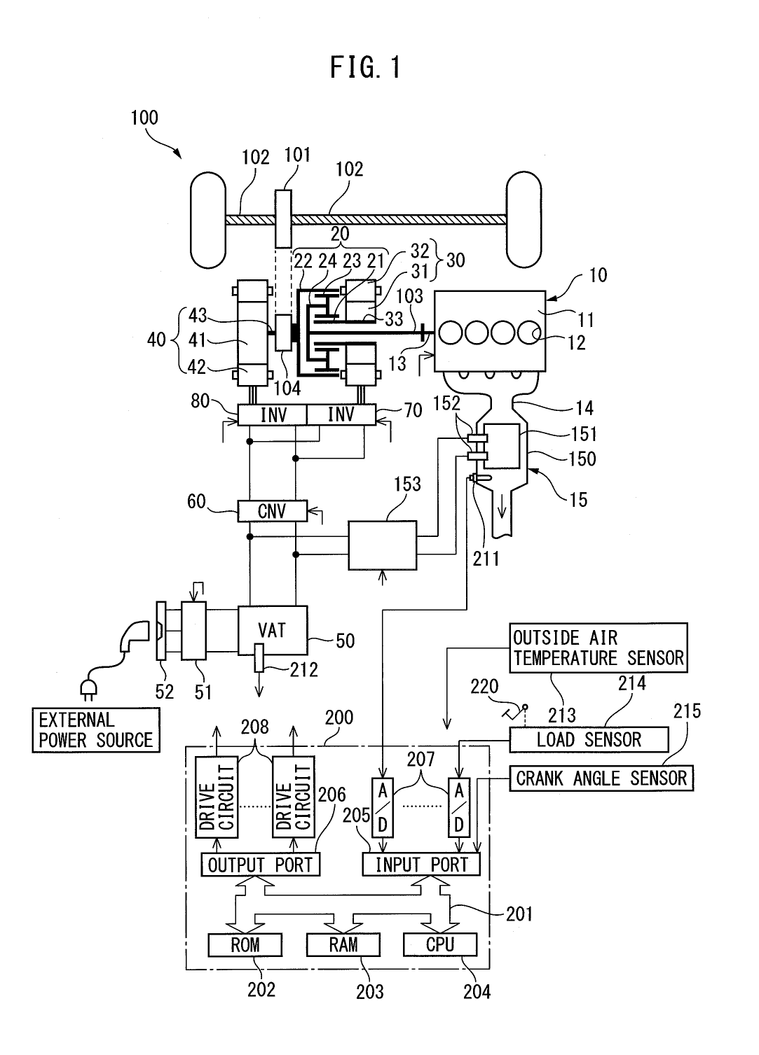

FIG. 1 is a schematic view of the configuration of a vehicle 100 and an electronic control unit 200 controlling the vehicle 100 according to one embodiment of the present invention.

As shown in FIG. 1, the vehicle 100 according to the present embodiment is provided with an internal combustion engine 10, power dividing mechanism 20, first rotary electric machine 30, second rotary electric machine 40, battery 50, booster converter 60, first inverter 70, and second inverter 80. The vehicle 100 is a hybrid vehicle configured to enable power of one or both of the internal combustion engine 10 and second rotary electric machine 40 to be transmitted to a wheel drive shaft 102 driven through a final speed reduction device 101, more specifically a plug-in hybrid vehicle configured to be able to use the electric power of an external power source to charge the battery 50.

The internal combustion engine 10 causes fuel to burn in the cylinders 12 formed in the engine body 11 and generates power for making an output shaft 103 connected to the crankshaft 13 rotate. The internal combustion engine 10 according to the present embodiment is a gasoline engine, but may also be made a diesel engine. Note that, in FIG. 1, only the engine body 11 and parts of the exhaust system of the internal combustion engine 10 are shown. Illustration of other parts is omitted.

The exhaust discharged from the cylinders 12 to an exhaust passage 14 flows through the exhaust passage 14 and is discharged into the atmosphere. In the exhaust passage 14, an electrical heated catalyst (EHC) device 15 is provided for removing the harmful substances in the exhaust.

The electrical heated catalyst device 15 is provided with a honeycomb shaped conductive carrier 151 carrying a catalyst on its surface, a pair of electrodes 152 for supplying voltage to the conductive carrier 151, and a voltage adjusting circuit 153 for adjusting the voltage supplied to the conductive carrier 151.

The conductive carrier 151 is a carrier formed by, for example, silicon carbide (SiC) or molybdenum disilicide (MoSi₂) or other material generating heat by being supplied with current and is provided inside the exhaust passage 14. In the present embodiment, a three-way catalyst is carried on the surface of the conductive carrier 151, but an oxidation catalyst may also be carried. It is possible to suitably select the catalyst required for obtaining the desired exhaust purification performance from among the various catalysts and carry it on the conductive carrier 151.

Downstream of the conductive carrier 151, a catalyst bed temperature sensor 211 is provided for detecting the temperature of the conductive carrier 151 (below, referred to as “the catalyst bed temperature”).

A pair of electrodes 152 are respectively electrically connected to the conductive carrier 151 and connected through the voltage adjusting circuit 153 to the battery 50. By supplying voltage through the pair of electrodes 152 to the conductive carrier 151 to supply electric power to the conductive carrier 151, current flows through the conductive carrier 151, the conductive carrier 151 generates heat, and the catalyst carried on the conductive carrier 151 is heated. The voltage applied to the conductive carrier 151 by the pair of electrodes 152 can be adjusted by the electronic control unit 200 controlling the voltage adjusting circuit 153. For example, it is possible to apply voltage of the battery 50 as it is and possible to apply voltage of the battery 50 lowered to any voltage.

The power dividing mechanism 20 is a planetary gear mechanism for dividing the power of the internal combustion engine 10 into two systems of power for making the wheel drive shaft 102 rotate and power for driving the first rotary electric machine 30 for regenerative operation and is provided with a sun gear 21, ring gear 22, pinion gears 23, and planetary carrier 24.

The sun gear 21 is an external gear and is arranged at the center of the power dividing mechanism 20. The sun gear 21 is coupled with a rotary shaft 33 of the first rotary electric machine 30.

The ring gear 22 is an internal gear and is placed around the sun gear 21 so as to be concentric with the sun gear 21. The ring gear 22 is coupled with a rotary shaft 43 of the second rotary electric machine 40. Further, at the ring gear 22, a drive gear 104 is integrally attached so as to transmit rotation of the ring gear 22 through the final speed reduction device 101 to the wheel drive shaft 102.

The pinion gears 23 are external gears and are placed between the sun gear 21 and ring gear 22 so as to mesh with the sun gear 21 and the ring gear 22.

The planetary carrier 24 is coupled with the output shaft 103 of the internal combustion engine 10 and rotates about the output shaft 103. Further, the planetary carrier 24 is also coupled with the pinion gears 23 so as to enable the pinion gears 23 to individually rotate (turn) while they rotate (orbit) around the sun gear 21 when the planetary carrier 24 is rotating.

The first rotary electric machine 30, for example, is a three-phase alternating current synchronous type motor-generator which is provided with a rotor 31 attached around the outer circumference of a rotary shaft 33 coupled with the sun gear 21 and having a plurality of permanent magnets embedded in its outer circumferential part and a stator 32 around which is wound an excitation coil generating a rotating magnetic field. The first rotary electric machine 30 has the function of a motor receiving the supply of electric power from the battery 50 and driving powered operation and the function of a generator receiving drive power of the internal combustion engine 10 and driving regenerative operation.

In the present embodiment, the first rotary electric machine 30 is mainly used as a generator. Further, when it is necessary to rotate the crankshaft 13 without burning fuel in the internal combustion engine 10, that is, when it is necessary to perform motoring for rotating the output shaft 103 to rotate the crankshaft 13 of the internal combustion engine 10 by an external force, the first rotary electric machine 30 is used as a motor.

The second rotary electric machine 40 is, for example, a three-phase alternating current synchronous type motor-generator and is provided with a rotor 41 attached around the outer circumference of a rotary shaft 43 coupled with the ring gear 22 and having a plurality of permanent magnets embedded in its outer circumferential part and a stator 42 around which is wound an excitation coil generating a rotating magnetic field. The second rotary electric machine 40 has the function of a motor receiving the supply of electric power from the battery 50 and driving powered operation and the function of a generator receiving drive power from the wheel drive shaft 102 at the time of deceleration of the vehicle 100 etc. and driving regenerative operation.

The battery 50 is, for example, a nickel-cadmium storage battery or nickel-hydrogen storage battery, lithium ion battery, or other rechargeable battery. In the present embodiment, as the battery 50, a lithium ion battery having a rated voltage of 200V or so is used. The battery 50 is electrically connected through the booster converter 60 etc. to the first rotary electric machine 30 and second rotary electric machine 40 so as to supply charged electrical power of the battery 50 to the first rotary electric machine 30 and second rotary electric machine 40 to drive powered operation of the same and further so as to enable the generated electrical power of the first rotary electric machine 30 and second rotary electric machine 40 to be charged to the battery 50.

Further, the battery 50 is electrically connected through the voltage adjusting circuit 153 and pair of electrodes 152 to the conductive carrier 151 as well so as to enable the charged electrical power of the battery 50 to be supplied to the conductive carrier 151 of the electrical heated catalyst device 15 to heat the conductive carrier 151.

Furthermore, the battery 50 according to the present embodiment, for example, is configured to be able to be electrically connected through a charging control circuit 51 and charging lid 52 to an external power source to enable charging from a household power outlet or other external power source (plug-in charging). The charging control circuit 51 is an electrical circuit converting alternating current supplied from the external power source to a direct current and boosting the input voltage to the battery voltage to charge the electrical power of the external power source in the battery 50 based on a control signal from the electronic control unit 200.

The booster converter 60 is provided with an electrical circuit able to boost a terminal voltage of a primary side terminal and output it from a secondary side terminal and conversely lower a terminal voltage of the secondary side terminal and output it from the primary side terminal based on a control signal from the electronic control unit 200. The primary side terminal of the booster converter 60 is connected to the output terminal of the battery 50, while the secondary side terminal is connected to the direct current side terminals of the first inverter 70 and the second inverter 80.

Each of the first inverter 70 and the second inverter 80 is provided with an electrical circuit able to convert direct current input from a direct current side terminal to alternating current (in the present embodiment, three-phase alternating current) and output it from an alternating current side terminal based on a control signal from the electronic control unit 200 and conversely able to convert alternating current input from an alternating current side terminal to direct current and output it from a direct current side terminal based on a control signal from the electronic control unit 200. The direct current side terminal of the first inverter 70 is connected to a secondary side terminal of the booster converter 60, while the alternating current side terminal is connected to the input/output terminal of the first rotary electric machine 30. The direct current side terminal of the second inverter 80 is connected to the secondary side terminal of the booster converter 60, while the alternating current side terminal is connected to the input/output terminal of the second rotary electric machine 40.

The electronic control unit 200 is comprised of a digital computer and is provided with components connected with each other by a bidirectional bus 201 such as a ROM (read only memory) 202, RAM (random access memory) 203, CPU (microprocessor) 204, input port 205, and output port 206.

The input port 205 receives as input the output signals of not only the above-mentioned catalyst bed temperature sensor 211, but also the SOC sensor 212 for detecting the charged amount of the battery, the outside air temperature sensor 213 for detecting the outside air temperature, etc. through corresponding AD converters 207. Further, the input port 205 receives as input the output voltage of the load sensor 214 generating an output voltage proportional to the amount of depression of an accelerator pedal 220 through a corresponding AD converter 207. Further, the input port 205 receives as input as a signal for calculating the engine rotational speed etc. an output signal of a crank angle sensor 215 generating an output pulse each time a crankshaft 13 of the engine body 11 rotates by for example 15°. In this way, the input port 205 receives as input the output signals of the various sensors required for controlling the vehicle 100.

The output port 206 is electrically connected through corresponding drive circuits 208 to control parts of the vehicle 100.

The electronic control unit 200 outputs control signals for driving the control parts to control the vehicle 100 from the output port 206 based on the output signals of the various sensors input to the input port 205. Below, the driving control of the vehicle 100 which the electronic control unit 200 performs will be explained.

The electronic control unit 200 sets the driving mode of the vehicle 100 based on the charged amount of the battery. Specifically, the electronic control unit 200 sets the driving mode of the vehicle 100 to the EV (electric vehicle) mode when the charged amount of the battery is a predetermined mode switching charged amount (for example 25% of full charged amount) or more. The EV mode is also sometimes called the CD (charge depleting) mode.

When the driving mode of the vehicle 100 is set to the EV mode, the electronic control unit 200 basically uses the charged electric power of the battery 50 in the state where the internal combustion engine 10 is stopped so as to drive the second rotary electric machine 40 for powered operation and uses only the power of the second rotary electric machine 40 to make the wheel drive shaft 102 rotate. Further, the electronic control unit 200 operates the internal combustion engine 10 and uses the drive powers of both the internal combustion engine 10 and second rotary electric machine 40 to make the wheel drive shaft 102 rotate as an exception when a predetermined engine operating condition stands.

The engine operating condition in the EV mode is one which is set from the viewpoints of securing the drivability of the vehicle 100 and protection of the parts. For example, the time when the vehicle speed becomes a predetermined vehicle speed (for example 100 km/h) or more, the time when the amount of depression of the accelerator pedal increases and the output demanded by the vehicle set based on the amount of depression of the accelerator pedal and vehicle speed becomes a predetermined output or more (time of demand of rapid acceleration), the time when the battery temperature becomes a predetermined temperature (for example −10° C.) or less, etc. may be mentioned.

In this way, the EV mode is a mode in which the charged electric power of the battery 50 is preferentially utilized to drive the second rotary electric machine 40 for powered operation and at least the drive power of the second rotary electric machine 40 is transmitted to the wheel drive shaft 102 to drive the vehicle 100.

On the other hand, the electronic control unit 200 sets the driving mode of the vehicle 100 to the fly (hybrid vehicle) mode when the charged amount of the battery is less than the mode switching charged amount. The HV mode is sometimes also called the CS (charge sustaining) mode.

When the driving mode of the vehicle 100 is set to the HV mode, the electronic control unit 200 divides the drive power of the internal combustion engine 10 into two systems by the power dividing mechanism 20, transmits one divided drive power of the internal combustion engine 10 to the wheel drive shaft 102, and uses the other drive power to drive the first rotary electric machine 30 for regenerative operation. Further, basically, the generated electric power of the first rotary electric machine 30 is used to drive the second rotary electric machine 40 for powered operation and the drive power of the second rotary electric machine 40 is transmitted to the wheel drive shaft 102 in addition to the other drive power of the internal combustion engine 10. When as an exception, for example, the amount of depression of the accelerator pedal increases and the vehicle demanded output has become a predetermined output or more etc., to secure the driving performance of the vehicle 100, the generated electric power of the first rotary electric machine 30 and the charged electric power of the battery 50 are used to drive the second rotary electric machine 40 for powered operation and the drive powers of both of the internal combustion engine 10 and second rotary electric machine 40 are transmitted to the wheel drive shaft 102.

In this way, the HV mode is the mode where the internal combustion engine 10 is operated and the electric power generated by the first rotary electric machine 30 is preferentially utilized to drive the second rotary electric machine 40 for a powered operation and the drive powers of both the internal combustion engine 10 and second rotary electric machine 40 are transmitted to the wheel drive shaft 102 to drive the vehicle 100.

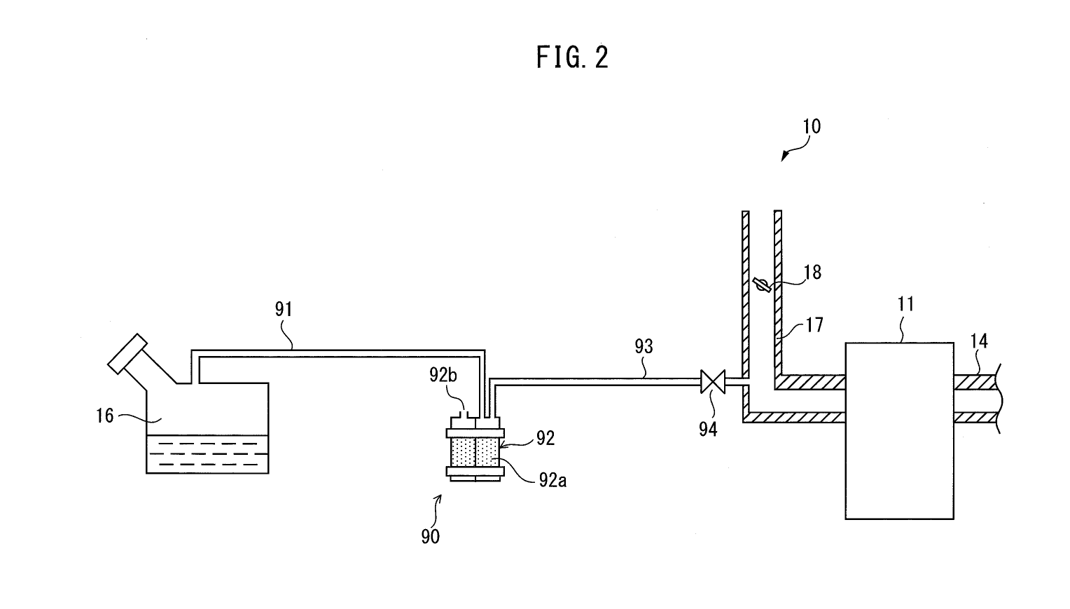

Next, referring to FIG. 2, the configuration of the fuel evaporative emission treatment device 90 which the internal combustion engine 10 is provided with will be explained.

The fuel evaporative emission treatment device 90 is a device for keeping the fuel evaporative emission generated inside the fuel tank 16 storing the fuel supplied to the internal combustion engine 10 from being discharged into the atmosphere. As shown in FIG. 2, the fuel evaporative emission treatment device 90 is provided with a connecting passage 91, canister 92, purge passage 93, and purge valve 94.

The connecting passage 91 is a passage for connecting the inside of the fuel tank 16 and the inside of the canister 92. The fuel evaporative emission occurring inside of the fuel tank 16 is introduced through the connecting passage 91 to the inside of the canister 92 by the pressure difference between the internal pressure of the fuel tank 16 and the internal pressure of the canister 92.

The canister 92 is filled inside it with for example activated carbon or another fuel adsorbing material 92a. The fuel adsorbing material 92a temporarily adsorbs and holds the fuel particles (hydrocarbons) of the fuel evaporative emission flowing through the connecting passage 91 to the inside of the canister 92. The gas from which the fuel particles have been removed is discharged from an air opening 92b provided at the canister 92 to the outside of the canister 92 (air).

The purge passage 93 is a passage for connecting the inside of the canister 92 and the inside of the intake passage 17 of the internal combustion engine 10 (in more detail, the intake passage at the downstream side from the throttle valve 18 in the direction of flow of intake).

The purge valve 94 is a normally closed type solenoid valve provided in the purge passage 93 and is opened by a control signal from the electronic control unit 200.

In this regard, there is an upper limit to the amount of fuel particles able to be adsorbed at the fuel adsorbing material 92a filled at the inside of the canister 92. For this reason, if the amount of fuel particles adsorbed at the fuel adsorbing material 92a (below, referred to as the “amount of adsorbed fuel particles”) reaches the predetermined upper limit amount of adsorption, further fuel particles can no longer be adsorbed by the fuel adsorbing material 92a. Therefore, if fuel evaporative emission flows in through the connecting passage 91 to the inside of the canister 92 in the state where the amount of adsorbed fuel particles reaches the upper limit amount of adsorption, fuel evaporative emission will end up leaking from the air opening 92b of the canister 92 as is to the outside.

For this reason, periodically or when judging the amount of adsorbed fuel particles is liable to reach the upper limit amount of adsorption, the electronic control unit 200 performs purge control opening the purge valve 94 to make fuel particles be desorbed from the fuel adsorbing material 92a when performing a drive operation by combustion making the fuel burn to drive the internal combustion engine 10.

By opening the purge valve 94 when driving the internal combustion engine 10 by combustion, due to the negative pressure of suction caused inside the intake passage 17, it is possible to suck in air from the air opening 92b to the inside of the canister 92. Further, the sucked in air can be run through the inside of the canister 92 in which the fuel adsorbing material 92a is filled and the purge passage 93 to introduce it into the intake passage 17 and in turn the cylinders 12.

Due to this, the air sucked in from the air opening 92b to the inside of the canister 92 can be used to make the fuel particles adsorbed at the fuel adsorbing material 92a be desorbed from the fuel adsorbing material 92a. Further, it is possible to introduce fuel particles desorbed from the fuel adsorbing material 92a together with the sucked in air to the cylinders 12 and make them burn inside the cylinders 12. That is, it is possible to discharge the fuel particles inside the canister 92 from the inside of the canister 92 and make them burn inside the cylinders 12.

In this way, at the time of driving the internal combustion engine 10 by combustion, by opening the purge valve 94 as required, it is possible to make fuel particles be desorbed from the fuel adsorbing material 92a, so it is possible to keep the amount of adsorbed fuel particles from ending up reaching the upper limit amount of adsorption. That is, it is possible to keep the fuel evaporative emission from ending up leaking from the air opening 92b of the canister 92 to the outside.

However, fuel evaporative emission occurs inside the fuel tank 16 even while not driving the internal combustion engine 10, so if the time of not driving the internal combustion engine 10 becomes longer, the fuel evaporative emission is liable to leak out from the air opening 92b of the canister 92 to the outside.

Here, in the case of a vehicle provided with only an internal combustion engine 10 as a source of drive power, the internal combustion engine 10 is driven along with the startup of the vehicle. On the other hand, in the case of a hybrid vehicle or plug-in hybrid vehicle or other such vehicle 100 like in the present embodiment provided with an internal combustion engine 10 and second rotary electric machine 40 as sources of drive power and able to be driven by just drive power of the second rotary electric machine 40, even if the vehicle 100 is started up, the internal combustion engine 10 will not necessarily be driven. The vehicle 100 will sometimes reach the destination without the internal combustion engine 10 being driven even once and then be stopped.

For this reason, in a hybrid vehicle or a plug-in hybrid vehicle, the time during which the internal combustion engine 10 is not driven tends to become longer and the possibility of the fuel evaporative emission leaking from the air opening 92b of the canister 92 to the outside becomes higher.

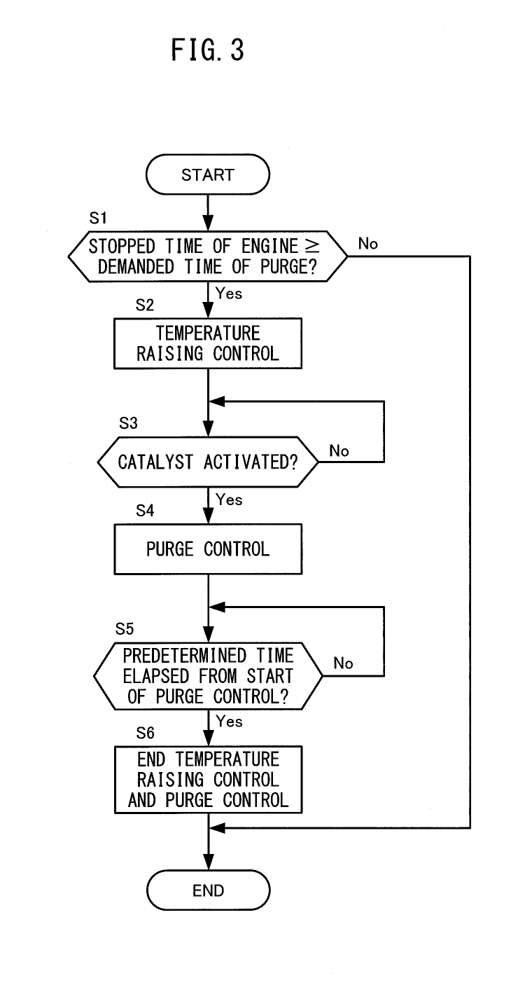

Therefore, in the present embodiment, even during the stopped time of the vehicle from when the vehicle 100 is stopped to when it is restarted, it is made possible to make the fuel particles be desorbed from the fuel adsorbing material 92a according to need and suitably treat the desorbed fuel particles. Below, referring to FIG. 3, the stopped purge control according to the present embodiment will be explained.

FIG. 3 is a flow chart explaining stopped purge control according to the present embodiment. The electronic control unit 200 periodically performs this routine during the stopped time of a vehicle.

At step S1, the electronic control unit 200 judges if a time elapsed from when the internal combustion engine 10 was stopped (below, referred to as the “stopped time of the engine”) is a predetermined demanded time of the purge (for example 48 hours) or more. If the stopped time of the engine is the demanded time of the purge or more, the electronic control unit 200 judges that it is preferable to make the fuel particles adsorbed at the fuel adsorbing material 92a inside the canister 92 be desorbed once and proceeds to the processing of step S2. On the other hand, the electronic control unit 200 ends the current processing if the stopped time of the engine is less than the demanded time of the purge.

Note that, the fuel evaporative emission occurring inside of the fuel tank 16 becomes greater in amount the higher the outside air temperature, so if providing an outside air temperature sensor 213 like in the vehicle 100 according to the present embodiment, it is also possible to make the demanded time of the purge change in accordance with the outside air temperature. Specifically, when the outside air temperature is high, the demanded time of the purge may be made shorter than when it is low.

At step S2, the electronic control unit 200 performs temperature raising control using the electric power of the battery 50 to supply current to the conductive carrier 151 to make the temperature of the conductive carrier 151 rise.

At step S3, the electronic control unit 200 judges if the catalyst has become active. In the present embodiment, the electronic control unit 200 judges if the temperature of the conductive carrier 151 (catalyst bed temperature) has become a predetermined activation temperature (for example 600° C.) or more. The electronic control unit 200 proceeds to the processing of step S4 if the catalyst bed temperature is the activation temperature or more. On the other hand, if the catalyst bed temperature is less than the activation temperature, the electronic control unit 200 stands by until the temperature becomes the activation temperature or more. Note that whether the catalyst has become active is not limited to being judged by the above such method. It may also be judged by for example whether the time of supply of current to the conductive carrier 151 has become a predetermined time or more.

At step S4, the electronic control unit 200 performs purge control during the vehicle stopped time. Specifically, the electronic control unit 200 performs motoring of the internal combustion engine 10 by driving the first rotary electric machine with the electric power of the battery 50 in order to rotate the output shaft 103 and eventually the crankshaft 13 and opens the purge valve 94.

Due to this, in the same way as the time of driving the internal combustion engine 10 by combustion, it is possible to use the negative pressure of suction formed inside the intake passage 17 to suck in air from the air opening 92b to the inside of the canister 92. Further, it is possible to introduce the fuel particles desorbed from the fuel adsorbing material 92a together with the sucked in air through the purge passage 93, intake passage 17, cylinders 12 of the engine body 11, and exhaust passage 14 to the catalyst device 15 in the state with the catalyst activated. For this reason, it is possible to purify the fuel particles at the catalyst and discharge them from the exhaust passage 14. Specifically, it is possible to make the fuel particles (hydrocarbon) oxidize to convert them to water and carbon dioxide and discharge them from the exhaust passage 14.

At step S5, the electronic control unit 200 judges if the time elapsed from the start of the purge control has become a predetermined time (for example 3 minutes) or more. If the elapsed time from the start of the purge control has become the predetermined time or more, the electronic control unit 200 judges that the fuel particles adsorbed at the fuel adsorbing material 92a have finished being desorbed and proceeds to the processing of step S6. On the other hand, if the time elapsed from the start of processing of step S4 is less than a predetermined time, the electronic control unit 200 continues to make the fuel particles adsorbed at the fuel adsorbing material 92a be desorbed.

At step S6, the electronic control unit 200 makes the temperature raising control and purge control end. Specifically, the electronic control unit 200 stops the supply of current to the conductive carrier 151 and motoring of the internal combustion engine 10 and closes the purge valve 94.

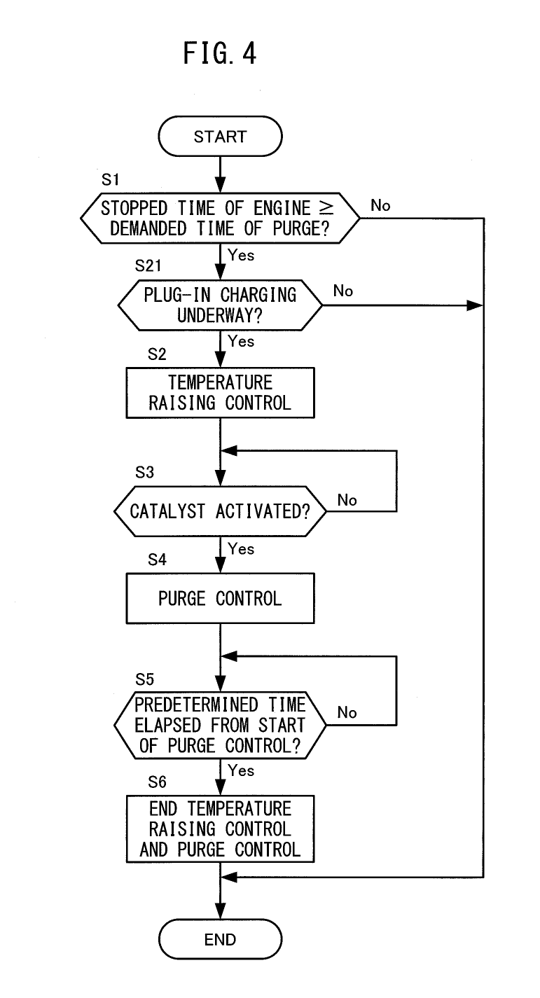

Note that, in this way, in stopped purge control, it is necessary to use the electric power of the battery 50 to heat the conductive carrier 151 and perform motoring of the internal combustion engine 10. For this reason, in the case of a plug-in hybrid vehicle, as in stopped purge control according to a modification of the present embodiment shown in FIG. 4, at step S21, it is also possible to judge if the vehicle is being charged by plug-in charging and proceed to the processing of step S2 only when the vehicle is being charged by plug-in charging.

Due to this, it is possible to use the inexpensive external electric power during plug-in charging to heat the conductive carrier 151 and perform motoring of the internal combustion engine 10. Further, it is possible to keep the charged amount of the battery from decreasing due to performing the stopped purge control, so it is possible to keep the distance over which the vehicle can be driven in the EV mode from becoming shorter and possible to keep the fuel efficiency from deteriorating.

According to the present embodiment explained above, there is provided an electronic control unit 200 (control device) for controlling a vehicle (hybrid vehicle) 100 able to transmit power of one or both of an internal combustion engine 10 and second rotary electric machine 40 to a driven object. The vehicle 100 includes an internal combustion engine 10, a fuel tank 16 storing fuel for supply to the internal combustion engine 10, a canister 92 holding by adsorption inside it fuel particles in fuel evaporative emission occurring at the fuel tank 16, a purge passage 93 connecting an intake passage 17 of the internal combustion engine 10 and the canister, a purge valve 94 provided at the purge passage 93 to open and close the purge passage, a rechargeable battery 50, an electrical heated catalyst device 15 provided in an exhaust passage 14 of the internal combustion engine 10 and including a conductive carrier 151 (heating element) generating heat by electric power supplied from the battery 50 and a catalyst heated through the conductive carrier 151, a first rotary electric machine 30 driven by electric power supplied from the battery 50 and able to perform motoring of the internal combustion engine 10, and a second rotary electric machine 40 driven by at least electric power supplied from the battery 50. The electronic control unit 200 is provided with a judging part configured to judge if the time elapsed from when the internal combustion engine 10 was stopped during the stopped time of the vehicle 100 has become a demanded time of the purge (predetermined time) or more, a temperature raising control part configured to perform temperature raising control supplying current to the conductive carrier 151 to make the temperature of the catalyst rise when it is judged that the elapsed time has become the demanded time of the purge or more, and a purge control part configured to perform purge control performing motoring of the internal combustion engine 10 by the first rotary electric machine 30 and opening the purge valve 94 when the temperature of the catalyst has become a predetermined temperature or more or when a time of supply of current to the heating element has become a predetermined time or more such that fuel particles held by adsorption at the inside of the canister 92 is discharged into the intake passage 17 to supply them to the catalyst device 15.

Due to this, during the stopped time of the vehicle 100, it is possible to cause the generation of negative pressure of suction inside the intake passage 17 and suck in air from the air opening 92b to the inside of the canister 92 and introduce the fuel particles desorbed from the fuel adsorbing material 92a together with the sucked in air through the purge passage 93, intake passage 17, cylinders 12 of the engine body 11, and exhaust passage 14 to the catalyst device 15 in the state with the catalyst activated. For this reason, it is possible to purify the fuel particles (hydrocarbons) at the catalyst and discharge them from the exhaust passage 14.

In this way, according to the present embodiment, during the stopped time of the vehicle 100, it is possible to make fuel particles adsorbed at the fuel adsorbing material 92a inside the canister 92 be desorbed and be suitably treated as required. Therefore, during the stopped time of the vehicle 100, it is possible to keep fuel evaporative emission from leaking to the outside and being released into the atmosphere.

At this time, it is also possible to configure the judging part judging whether the time elapsed from when the internal combustion engine 10 was stopped has become a demanded time of the purge or more during the stopped time of the vehicle 100 so as to shorten the demanded time of the purge when the outside air temperature is high compared to when it is low.

Due to this, during the stopped time of the vehicle 100, it is possible to cause fuel particles adsorbed on the fuel adsorbing material 92a to be desorbed and suitably treat them at a suitable timing corresponding to the amount of occurrence of fuel evaporative emission.

Further, according to a modification of the present embodiment, the electronic control unit 200 is configured to perform the temperature raising control and purge control when charging electric power of an external power source into the battery 50.

Due to this, inexpensive outside electric power available during plug-in charging can be used to perform the heating of the conductive carrier 151 and motoring of the internal combustion engine 10. Further, it is possible to keep the amount of charging of the battery from falling due to performing the stopped purge control, so it is possible to keep the distance able to be driven by the EV mode from becoming shorter and possible to keep the fuel efficiency from deteriorating.

Above, embodiments of the present invention were explained, but the embodiments only show part of the examples of application of the present invention and are not meant to limit the technical scope of the present invention to the specific constitutions of the above embodiments.

1. A control device for a hybrid vehicle,
the hybrid vehicle comprising:
an internal combustion engine;
a fuel tank storing fuel for supply to the internal combustion engine;
a canister adsorbing and holding inside it fuel particles in fuel evaporative emission occurring in the fuel tank;
a purge passage connecting an intake passage of the internal combustion engine and the canister;
a purge valve provided in the purge passage to open and close the purge passage;
a rechargeable battery;
an electrical heated catalyst device provided in an exhaust passage of the internal combustion engine and including a heating element generating heat by electric power supplied from the battery and a catalyst heated through the heating element;
a first rotary electric machine driven by electric power supplied from the battery and able to perform motoring of the internal combustion engine; and
a second rotary electric machine driven by at least electric power supplied from the battery, wherein
the hybrid vehicle is configured to be able to transmit power of one or both of the internal combustion engine and second rotary electric machine to a driven object, and
the control device comprises:
a judging part configured to judge if a time elapsed from when the internal combustion engine was stopped became a predetermined time or more during a stopped time of the hybrid vehicle;
a temperature raising control part configured to perform temperature raising control running current through the heating element to make the temperature of the catalyst rise when it was judged that the elapsed time became a predetermined time or more; and
a purge control part configured to perform purge control performing motoring of the internal combustion engine by the first rotary electric machine and opening the purge valve when the temperature of the catalyst has become a predetermined temperature or more or when a time of supply of current to the heating element has become a predetermined time or more such that fuel particles held by adsorption at the inside of the canister is discharged into the intake passage to supply them to the catalyst device.

2. The control device for the hybrid vehicle according to claim 1, wherein
the battery is configured to be able to be charged by electric power of an external power source, and
the temperature raising control and the purge control are performed when charging electric power of the external power source at the battery.

3. The control device for a hybrid vehicle according to claim 1, wherein
the judging part is further configured to shorten the predetermined time when an outside air temperature is high compared to when it is low.

4. A hybrid vehicle comprising:
an internal combustion engine;
a fuel tank storing fuel for supply to the internal combustion engine;
a canister adsorbing and holding inside it fuel particles in fuel evaporative emission occurring in the fuel tank;
a purge passage connecting an intake passage of the internal combustion engine and the canister;
a purge valve provided in the purge passage to open and close the purge passage;
a rechargeable battery;
an electrical heated catalyst device provided in an exhaust passage of the internal combustion engine and including a heating element generating heat by electric power supplied from the battery and a catalyst heated through the heating element;
a first rotary electric machine driven by electric power supplied from the battery and able to perform motoring of the internal combustion engine;
a second rotary electric machine driven by at least electric power supplied from the battery; and
a control device, wherein
the hybrid vehicle is configured to be able to transmit power of one or both of the internal combustion engine and second rotary electric machine to a driven object, and
the control device is configured to:
judge if a time elapsed from when the internal combustion engine was stopped became a predetermined time or more during a stopped time of the hybrid vehicle;
perform temperature raising control running current through the heating element to make the temperature of the catalyst rise when it was judged that the elapsed time became a predetermined time or more; and
perform purge control performing motoring of the internal combustion engine by the first rotary electric machine and opening the purge valve when the temperature of the catalyst has become a predetermined temperature or more or when a time of supply of current to the heating element has become a predetermined time or more such that fuel particles held by adsorption at the inside of the canister is discharged into the intake passage to supply them to the catalyst device.
